(19) United States
(12) Patent Application Publication
(10) Pub. No.: US 2024/0289641 A1
(43) Pub. Date: Aug. 29, 2024

(54) Systems and Methods for Processing Data Using Interference and Analytics Engines

(71) Applicant: LOYOLA UNIVERSITY OF CHICAGO, Chicago, IL (US)

(72) Inventors: Ronald N. Price, JR., Darien, IL (US); Jason Boyda, Orland Park, IL (US); Kathleen Bobay, Elmhurst, IL (US)

(21) Appl. No.: 18/573,753

(22) PCT Filed: Jun. 14, 2022
(86) PCT No.: PCT/US22/33342

§ 371 Date: Dec. 22, 2023

Related U.S. Application Data
(60) Provisional application No. 63/217,516, filed on Jul. 1, 2021.

(51) Int. Cl. G06N 5/02; G06N 20/00

(52) U.S. Cl. CPC G06N 5/02; G06N 20/00

(57) ABSTRACT

Systems and methods disclosed herein efficiently infer information from structured and/or unstructured data, and/or efficiently perform natural language processing (NLP) of unstructured textual data. In one aspect. an NLP inference engine generates inferences from data records in a transactional manner (i.e., substantially in real time). The NLP inference engine automatically calls an NLP analytics engine to handle unstructured textual data within the data records. In another aspect. an NLP analytics engine executes a multi-thread mapping process that uses knowledge maps to map features of unstructured textual data to “candidate” feature attributes. and generates “accepted” feature attributes based at least in part on the candidate feature attributes.

### FIELD OF THE DISCLOSURE

The present disclosure generally relates to the processing of data in clinical and/or other use cases, and, more specifically, to techniques for efficiently processing unstructured and/or structured data with natural language processing and/or inference rules.

### BACKGROUND

The ability to quickly receive, evaluate, and respond to complex data is of great value in numerous areas. These capabilities are particularly important, for example, with respect to a wide range of clinical functions, such as computable phenotyping, clinical decision support, disease detection, risk profiling, medication alerting/notification, expert systems processes (e.g., processes utilizing machine learning), and so on. While there have been a number of advances in various technologies supporting such clinical functions, the basic approach to constructing clinical inference rules largely remains limited to inputting clinical data that is coded in a particular format (e.g., ICD9, ICD10, CPT, or SNOMED) and derived from structured elements (e.g., fields) in an existing electronic health record (EHR). Structured clinical data elements are typically discrete input values or codes, such as height, weight, diastolic blood pressure, diagnosis code, procedure code, and so on. However, limiting clinical inference rules to structured data elements of this sort means that a vast amount of clinical narrative data that is captured in a typical EHR (approximately 80% of such data) remains untapped. Moreover, while some conventional techniques can infer information from unstructured data, these techniques are simplistic (e.g., employing simple string or keyword matching that is insufficient for most non-trivial use cases), are computationally intensive (e.g., requiring complex and dedicated pre-processing, costly servers, and/or large amounts of time to process data records), involve a substantial amount of manual intervention, are highly task-specific (e.g., have complexities and requirements that severely limit adoption across a wide range of use cases, and indeed are often limited to a single use case), and/or are very difficult to replicate across different users, entities, and/or institutions.

To effectively analyze unstructured data that may be found in EHR or other records, natural language processing (NLP) techniques are generally required. However, incorporating complex NLP functions into inference rules requires significant technical sophistication (e.g., with installation, configuration, and operation of most NLP products being well beyond the capabilities of most principal investigators, students, and even information technology (IT) personnel). Even in isolation, this fact greatly limits the adoption or use of NLP in clinical research projects and decision-making activities. In addition, incorporation of NLP is typically performed in a “batch mode” or “pipeline” manner that creates a severe bottleneck, e.g., with current EHRs implementing NLP as an external process that can take several minutes or longer for each task. Thus, these techniques do not lend themselves to real-time, event-driven applications. Conventional NLP techniques are also associated with other technical problems, such as utilization of internal and core analysis modules that do not easily scale.

In addition to the challenge of using NLP in near-real-time operations, it is difficult to identify and build inference rules that incorporate NLP. For example, when using computable phenotyping for clinical research that requires NLP, it is challenging to include even retrospective or observational studies. Clinical researchers are tasked with trying to integrate NLP, and the even more advanced component of an inference rule, into their research methodologies. Conventionally, this has been an extremely daunting tasks for even the most technically-savvy clinical researcher. Even if a clinical researcher develops a suitable computable phenotype (or other type of inference rule), it can be difficult for other researchers to replicate the general approach or put the approach into production in a real-world operational environment. The inference rules are often embedded in conventional systems or processes as proprietary programs or algorithms that cannot easily be updated and/or extended, and are often difficult to transport to other systems and/or institutions.

Groups that do manage to clear clinical NLP hurdles at the research level go on to face additional hurdles with implementation of clinical NLP in actual health care settings. Notable challenges include localization (e.g., local dialectics or semantics) of clinical reports affecting clinical NLP quality, and difficulties with implementing clinical NLP in the context of an EHR platform. Arguably, the current “gold standard” product for clinical NLP is the clinical Text Analysis and Knowledge Extraction System (cTAKES), which originated from software development work that began at Mayo Clinic in 2006. This work has been open sourced through the Apache cTAKES project. The Apache cTAKES code base is built on JAVA, and now has numerous modules that can be configured together to construct a range of clinical NLP processes. However, the installation and configuration of JAVA and cTAKES is challenging. While use of JAVA as a technology stack enhances the portability of the code, this comes at the steep price of increased layers of complexity, increased requirements in computing resources (e.g., CPUs, memory, libraries, etc.), and decreased application performance. The original Apache cTAKES code base has propagated to a number of derivative products, and as a consequence these products inherently utilize the same core semantic typing methodologies and algorithms (and their same drawbacks/limitations).

Beyond the normal set-up and configuration challenges of Apache cTAKES and derivative products, the single and greatest factor limiting their use is performance. Current reported times for even a single clinical report to be processed can range from 40 to 55 seconds, with far longer times (e.g., over an hour) being possible in some circumstances (e.g., if cTAKES attempts to distinguish whether a data record indicates that a particular attribute is present or instead absent). While some reduction in processing time is possible through various modifications of cTAKES, there remain great impediments to the use of clinical NLP in any real-world health care setting where automated, transactional processes can demand sub-second response times, and/or require that multiple reports or notes be processed jointly rather than individually.

### BRIEF DESCRIPTION OF THE DRAWINGS

The figures described below depict various aspects of the system and methods disclosed herein. Each figure depicts an embodiment of a particular aspect of the disclosed system and methods, and each of the figures is intended to accord with a possible embodiment thereof.

FIG. 1 depicts an example system including components associated with analyzing and inferring information from data records.

FIG. 2 depicts example data processing that may be implemented by the clinical natural language processing (NLP) inference engine of FIG. 1 to infer information from one or more data records.

FIG. 3 depicts example data processing that may be implemented by the clinical NLP analytics engine of FIG. 1 to perform natural language processing tasks.

FIG. 4 depicts an example configuration of knowledge maps that the clinical NLP analytics engine of FIG. 1 may use to perform the knowledge mapping of FIG. 3.

FIGS. 5A-5D depict example user interfaces that may be generated and displayed by the system of FIG. 1.

FIGS. 6A-6C depict alternative example user interfaces that may instead, or also, be generated and displayed by the system of FIG. 1.

FIG. 7 depicts an example process for using the inferencing and analytics capabilities of the system of FIG. 1 in a clinical research application.

FIG. 8 depicts an example user interface of a real-time clinical decision support (CDS) application that uses the inferencing and analytics capabilities of the system of FIG. 1.

FIG. 9 depicts an example process for using the inferencing and analytics capabilities of the system of FIG. 1 on a personal device that supports user dictation.

FIG. 10 is a flow diagram of an example method for efficiently inferring information from one or more data records.

FIG. 11 is a flow diagram of an example method for efficient natural language processing of unstructured textual data.

### DETAILED DESCRIPTION

The embodiments disclosed herein generally relate to techniques for quickly yet rigorously analyzing data records, including unstructured textual data. For example, the disclosed embodiments include systems and methods that implement natural language processing (NLP) and/or inferencing engines capable of processing multiple, complex data records having widely varying characteristics (e.g., with different formats and/or stylistic differences, or written or dictated in different languages, etc.). Moreover, the disclosed embodiments include systems and methods capable of performing this processing in a transactional manner (e.g., substantially in real time). While the embodiments described herein relate primarily to clinical use cases, it is understood that other use cases are also within the scope of the disclosed subject matter. It is understood that, as used herein, “natural language processing” or “NLP” refers to processing beyond simple speech-to-text mapping, and encompasses, for example, techniques such as content analysis, concept mapping, and leveraging of positional, temporal, and/or statistical knowledge related to textual content.

A first aspect of the present disclosure relates to an NLP inference engine (“NIE” or, in the case of the clinical use cases discussed herein, “cNIE”). The cNIE is a general purpose engine, in some embodiments, and comprises a high-performance data analytics/inference engine that can be utilized in a wide-range of near-real-time clinical rule evaluation processes (e.g., computable phenotyping, clinical decision support operations, implementing risk algorithms, etc.). As used herein, terms such as “near-real-time” and “substantially in real time” encompass what those of ordinary skill in the relevant art would consider and/or refer to as simply “real time” (e.g., with delays that are barely noticeable or unnoticeable to a human user, such as less than 100 milliseconds, less than 10 milliseconds, less than 2 milliseconds, less than 1 millisecond, etc., provided that any relevant communication networks and processors are functioning properly, are not overloaded with other communications or processing, etc.).

In some embodiments, the cNIE can natively evaluate rules that include both structured data elements (e.g., EHRs with pre-defined, coded fields) and unstructured data elements (e.g., manually typed or dictated clinical notes) as inputs to inference operations (e.g., inference rules). Moreover, in some embodiments, the cNIE can use/access an engine that provides high-performance clinical NLP. This allows the cNIE to receive and process clinical records without any pre-processing, in some embodiments, such that the external EHR (or other system or application calling the cNIE) does not have to deal with the complexity of trying to feed pre-processed data to the inference engine. In some embodiments, the clinical NLP is performed by the clinical NLP analytics engine (cNAE) that is discussed in more detail below. In other embodiments, however, the cNIE calls a different clinical NLP engine (e.g., cTAKES, possibly after having modified the conventional cTAKES engine to instead utilize a REST API). In still other embodiments, a single program or application performs the functions of both the cNIE and the NLP engine (e.g., both the cNIE and the cNAE as described herein). Depending on the embodiment, the cNIE can address some or all of the issues with other clinical inferencing systems (e.g., as described above in the Background section), in both the clinical domain and the clinical research domain.

A second aspect of the present disclosure relates more specifically to the NLP analytics engine mentioned above (“NAE” or, in the case of the clinical use cases discussed herein, “cNAE”). Generally, the cNAE provides high-performance feature detection and knowledge mapping to identify and extract information/knowledge from unstructured clinical data. The cNAE may provide clinical NLP within or for the cNIE (e.g., when called by the cNIE to handle unstructured input data), or may be used independently of the cNIE (e.g., when called by an application other than the cNIE, or when used without any inference engine at all), depending on the embodiment.

Generally, the cNAE is a clinical analytics engine optimized to perform clinical NLP. The cNAE utilizes a concurrent processing algorithm to evaluate collections of “knowledge maps.” By doing so, the cNAE can, in some embodiments, perform far faster than conventional techniques such as cTAKES (e.g., hundreds to thousands of times faster), and with similar or superior NLP performance (e.g., in terms of recall, precision, accuracy, F-score, etc.). The cNAE can also be highly portable and relatively easy to get up and running. The knowledge maps of the cNAE may be expanded upon and/or modified (e.g., localized) through the addition of user-developed knowledge maps. In some embodiments, the cNAE is accessed through a defined REST API, to facilitate use of the cNAE across a wide range of use cases. The same cNAE software may be used for both clinical research and health care settings, for example. Depending on the embodiment, the cNAE can address some or all of the issues with conventional clinical NLP systems (e.g., as described above in the Background section), in both the clinical domain and the clinical research domain.

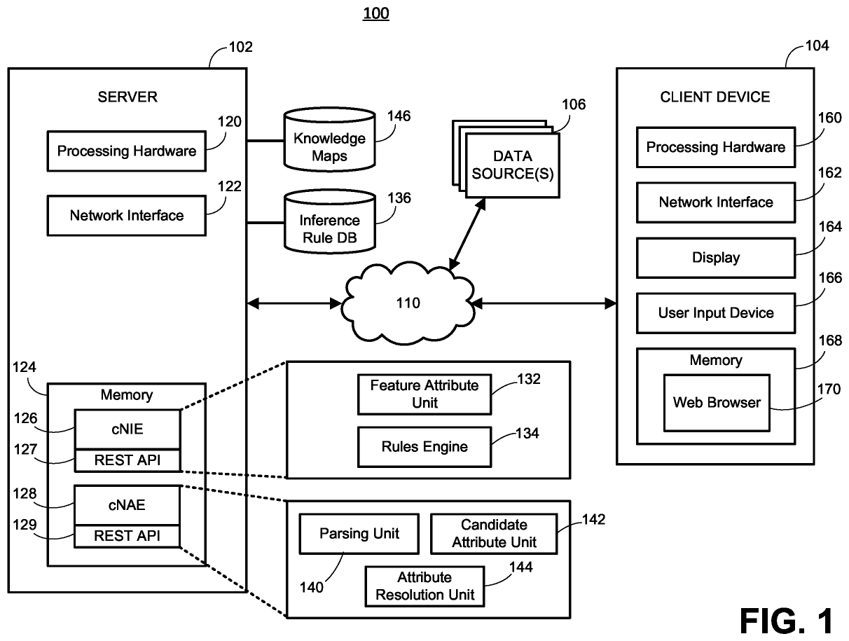

FIG. 1 depicts an example system 100 including components associated with analyzing and inferring information from data records, according to an embodiment. The example system 100 includes a server 102 and a client device 104, which are communicatively coupled to each other via a network 110. The system 100 also includes one or more data sources 106 communicatively coupled to the server 102 (and/or the client device 104) via the network 110. The network 110 may be a single communication network, or may include multiple communication networks of one or more types (e.g., one or more wired and/or wireless local area networks (LANs), and/or one or more wired and/or wireless wide area networks (WANs) such as the Internet).

The server 102, some or all of the data source(s) 106, and some or all of the network 100 may be maintained by an institution or entity such as a hospital, a university, a private company, etc. The server 102 may be a web server, for example. Generally, the server 102 obtains input data (e.g., data records containing structured and/or unstructured data), and processes the input data to infer information and/or generate analytics information. As used herein, and unless the context of use indicates a more specific meaning, “inferring” information from data broadly encompasses the determination of information based on that data, including but not limited to information about the past and/or present, the future (i.e., predicting information), and potential circumstances (e.g., a probability that some circumstance exists or will exist), and may include real-world and/or hypothetical information, for example. Thus, for instance, the “inferencing” performed by the server 102 may include processing a set of clinical records to determine whether a patient has a particular condition (e.g., osteoporosis, a particular type of cancer, rheumatoid arthritis, etc.), a probability of the patient having the condition, a probability that the patient is likely to develop the condition, and so on. As another example, the “inferencing” performed by the server 102 may determine whether a larger patient population (e.g., as reflected in numerous data records) exhibits or is likely to exhibit particular clinical conditions.

The server 102 may be a single computing device, or a collection of distributed (i.e., communicatively coupled local and/or remote) computing devices and/or systems, depending on the embodiment. The server 102 includes processing hardware 120, a network interface 122, and a memory 124. The processing hardware 120 includes one or more processors, each of which may be a programmable microprocessor that executes software instructions stored in the memory 124 to execute some or all of the functions of the server 102 as described herein. The processing hardware 120 may include one or more graphics processing units (GPUs) and/or one or more central processing units (CPUs), for example. In some embodiments, however, a subset consisting of one or more of the processors in the processing hardware 120 may include other types of processors (e.g., application-specific integrated circuits (ASICs), field-programmable gate arrays (FPGAs), etc.).

The network interface 122 may include any suitable hardware (e.g., front-end transmitter and receiver hardware), firmware, and/or software configured to use one or more communication protocols to communicate with external devices and/or systems (e.g., the client device 104, the computing system(s) of the data source(s) 106, etc.) via the network 110. For example, the network interface 122 may be or include an Ethernet interface.

The memory 124 may include one or more volatile and/or non-volatile memories. Any suitable memory type or types may be included in the memory 124, such as a read-only memory (ROM) and/or a random access memory (RAM), a flash memory, a solid-state drive (SSD), a hard disk drive (HDD), and so on. Collectively, the memory 124 may store the instructions of one or more software applications, the data received/used by those applications, and the data output/generated by those applications. In particular, the memory 124 stores the software instructions of a cNIE 126, and the instructions of a cNAE 128. The cNAE 128 may be a part of the cNIE 126, both may be separate applications, or both may be separate parts of a larger application, for example.

In some embodiments, the cNIE 126 and/or the cNAE 128 use concurrent processing techniques across multiple CPU cores and threads. For example, the cNIE 126 and/or the cNAE 128 may be Golang-based, executable binaries that use concurrent processing of this sort to provide high-performance across all major computing platforms. The efficient and portable (platform-independent) architectures of the cNIE 126 and cNAE 128 can allow extremely fast (e.g., near-real-time) processing, on virtually any computing hardware platform, with relatively simple installation and low installation times (e.g., under five minutes). For example, and regardless of whether the server 102 is in fact a server, the same (or nearly the same) software of the cNIE 126 and cNAE 128 may be implemented by cloud-based servers, desktops, laptops, Raspberry Pi devices, mobile/personal devices, and so on.

The cNIE 126 and cNAE 128 provide a REST API 127 and REST API 129, respectively, which generally allow for an extremely wide range of use cases. The REST APIs 127, 129 provide bi-directional communications with programs, processes, and/or systems through internal memory processes, or in a distributed manner using standard network protocols (e.g., TCP/IP, HTTP, etc.). In other embodiments, however, the API 127 and/or the API 129 is/are not RESTful (e.g., in architectures where the cNIE and/or cNAE are directly embedded or incorporated into other programs). The cNIE 126 and cNAE 128 may return results in JSON format, results that are already processed into a relational delimiter table, or results in any other suitable format.

Preferably, the cNIE 126 and cNAE 128 reside on the same device (e.g., server 102) in order to avoid processing inefficiencies. However, in some embodiments where the server 102 is a distributed computing system, portions of the cNIE 126 and the cNAE 128 may be stored in memories of different computing devices, and the operations of the cNIE 126 and the cNAE 128 may be performed collectively by the processors of different computing devices in the computing system. In still other embodiments, the memory 124 includes the cNIE 126 but omits the cNAE 128, or includes the cNAE 128 but omits the cNIE 126. That is, while the cNIE 126 and cNAE 128 may operate together synergistically to provide even better performance, significant benefits may still be obtained using either of the two engines on its own.

The example cNIE 126 of FIG. 1 includes a feature attribute unit 132 and a rules engine 134. Generally, the feature attribute unit 132 obtains feature attributes from data records (e.g., by inspecting coded data fields, and/or by utilizing the cNAE 128 to analyze unstructured data as discussed below), and the rules engine 134 applies appropriate inference rules from an inference rule database 136 to those feature attributes. In other embodiments, the cNIE 126 includes only the rules engine 134, while other software implements the functionality of the feature attribute unit 132.

The cNIE 126 may also include additional units not shown in FIG. 1. In concert with the multi-thread computational processes described herein the cNIE 126 may also implement related processes, such as internal processes to: track, manage, and manipulate rule sets; process functions, rule result values; load rule databases from storage into memory at initial program execution; perform a dynamic reload of rules while in operation; analyze inbound data in an API call to ensure that passed data is compliant with the targeted inference rule(s); associate inbound data with various components/elements specified by the inference rule(s); validate the structure and correctness of inbound and outbound data; determine which output types are appropriate for a given request; log processed requests; and so on.

In some embodiments, the cNIE 126 implements processes to determine whether input data is of a type that requires in-line analytic services, and to call that in-line service/process. For example, processes of the cNIE 126 may transparently call the cNAE 128 after determining that unstructured, inbound data requires NLP. This transparent function advantageously decouples NLP data processing complexity from rule definition. Processes of the cNIE 126 may also determine whether a processed result is a single, unified code collection (e.g., all of the same type/format, such as all CUIs), or instead a collection of code types that contain primary and secondary elements. The results returned by the cNAE 128 may be “multi-lingual” (e.g., mixes of ICD9, ICD10, SNOMED, LOINC, CPT, MESH, etc.) in their expression. The cNIE 126 processes may also intelligently select rules for execution, and/or cache results for greater computational efficiency, as discussed in further detail below.

Generally, the inference rules operate on feature attributes (e.g., as obtained from structured data and/or as output by the cNAE 128 or another NLP engine/resource) to infer (e.g., determine, predict, etc.) higher-level information. Individually or collectively, the inference rules may operate on components/elements specified according to multiple taxonomies (e.g., ICD9/10, SNOMED, MESH, RxNorm, LOINC, NIC, NOC, UMLS CUIs, etc.). This “multi-lingual” nature of the inference rules provides users with greater simplicity/case-of-use, and greater flexibility in design due to the fact that rule code sets may vary depending on the use case. The inference rules may be accessed and evaluated in the same manner regardless of platform or implementation domains (e.g., from clinical research to healthcare operations), thereby providing high portability.

The inference rule database 136 contains a rule library that may be stored in any suitable persistent memory (e.g., within the memory 124) or collection of persistent memories (e.g., distributed across numerous local and/or remote devices and/or systems). The database 136 may include thousands of rules, for example, such as rules that are crowd-sourced (preferably with some suitable degree of peer-review or other curation). Generally, it can be advantageous to have the inference rules incorporate a wide diversity of approaches and/or perspectives. For example, some inference rules may be manually created by experts in the primary field associated with the rule, while others may be manually created by experts in other, tangential fields that are pertinent to the analysis. As another example, different inference rules may be created in geographic regions in which the current thinking on various health-related matters can differ. In some embodiments, certain inference rules may be associated with other inference rules via cross-referencing, and/or may be related according to hierarchical structures, etc.

The example cNAE 128 of FIG. 1 includes a parsing unit 140, a candidate attribute unit 142, and an attribute resolution unit 144. Generally, the parsing unit 140 parses unstructured textual data into tokens (e.g., words, phrases, etc.), and the candidate attribute unit 142 detects features of interest from those tokens (e.g., particular tokens, and/or features that unit 142 derives from the tokens, such as word counts, positional relationships, etc.). The candidate attribute unit 142 then utilizes “knowledge maps” (from a collection of knowledge maps 146) to map the detected features to various feature attributes (also referred to herein as “concepts”). The knowledge maps 146 are discussed in further detail below. The feature attributes generated by unit 142 are “candidate” feature attributes, which the attribute resolution unit 144 processes to generate one or more “accepted” feature attributes (as discussed in further detail below). Preferably, units 140, 142, and 144 are all included in the cNAE 128. In other embodiments, however, the cNAE 128 includes only the candidate attribute unit 142 and attribute resolution unit 144 (e.g., with other software implementing the functionality of the parsing unit 140). The cNAE 128 may also include additional units not shown in FIG. 1.

In concert with the multi-thread computational processes described herein, the cNAE 128 may implement related processes, such as internal processes to: track, manage, and manipulate knowledge maps; verify the structure and correctness of inbound data; determine whether input is a single complex data object or a collection of data objects and process each as appropriate for the requested analysis; determine required output types as appropriate for the requested analysis; determine whether a single request is a part of a sequence of related requests that are processed asynchronously; and so on. The knowledge maps 146 may be stored in any suitable persistent memory (e.g., within the memory 124) or collection of persistent memories (e.g., distributed across numerous local and/or remote devices and/or systems).

Each of the knowledge maps 146 may be or include any data structure(s) (e.g., a relational database) and/or algorithm(s) that support rapid feature detection and analysis, to relate, translate, transform, etc., features of text to particular feature attributes. Text features may include particular tokens, token patterns, formats, bit patterns, byte patterns, etc. More specific examples may include specific words, phrases, sentences, positional relationships, word counts, and so on. Feature detection may include feature disambiguation and/or “best-fit” determinations on the basis of feature characteristics derived through statistical analysis and/or secondary attributes (e.g., weightings, importance factors, etc.), for example. Feature attributes may include any attributes that are explicitly or implicitly expressed by or otherwise associated with the features, such as specific codes (e.g., ICD9, ICD10, SNOMED, etc.), dates, ethnicity, gender, age, whether the features positively or negatively express other feature attributes, and so on.

Some relatively simple knowledge maps may employ relational databases that associate different features of text with different feature attributes (e.g., as specified by manual user entries). Knowledge maps may be constructed through the analysis of a large-scale Unstructured Information Management Architecture (UIMA) compliant data mass, and/or through targeted processes (either programmatic processes or by manual means), for example. In some embodiments, one or more of the knowledge maps 146 is/are generated using machine learning models that have been trained with supervised or unsupervised learning techniques.

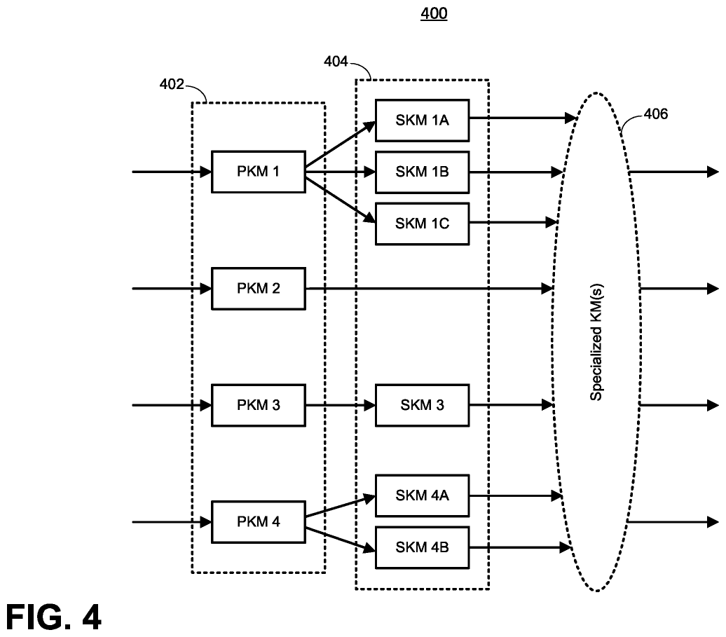

The knowledge maps (from knowledge maps 146) that are applied by the candidate attribute unit 142 may be arranged in any suitable configuration or hierarchy. In some embodiments, multiple knowledge maps are associated or “grouped” (e.g., share a common name or other identifier) to function cooperatively as a single analytical unit. In some embodiments, knowledge maps are designated into pools. As discussed further below with reference to FIG. 4, for example, the knowledge maps may include “primary” knowledge maps that are initially selected, as well as “secondary” knowledge maps that are associated with specific primary knowledge maps and are therefore selected as a corollary to selecting the corresponding primary knowledge maps. Secondary knowledge maps may perform a more detailed analysis, e.g., after application of (and/or in support of) the corresponding primary knowledge maps. The knowledge maps may also include “specialized” knowledge maps having other, more specialized functions, such as identifying negation (i.e., determining whether a particular feature attribute is negatively expressed).

Similar to the inference rules, it may be advantageous to incorporate knowledge maps that incorporate a wide diversity of approaches and/or perspectives. Moreover, knowledge maps may, individually or collectively, be “multi-lingual” insofar as they may recognize/understand different formats, different human languages or localizations, and so on, and may return feature attributes according to different code formats, taxonomies, syntaxes, and so on (e.g., as dictated by parameters specified when calling the REST API 129).

While some embodiments allow many users and client devices to access/utilize the cNIE 126 and/or cNAE 128 of the server 102, for clarity FIG. 1 illustrates only the example client device 104 of a single user. The client device 104 may be a computing device of a local or remote end-user of the system 100 (e.g., a doctor, resident, student, patient, etc.), and the end-user may or may not be associated with the institution or entity that maintains the server 102. Generally, the user operates the client device 104 to cause the server 102 to obtain and/or process particular sets of input data (e.g., specific records indicated by the user), in order to gain the desired knowledge and/or analytics as dictated by the use case (e.g., clinical decision support, research, etc.).

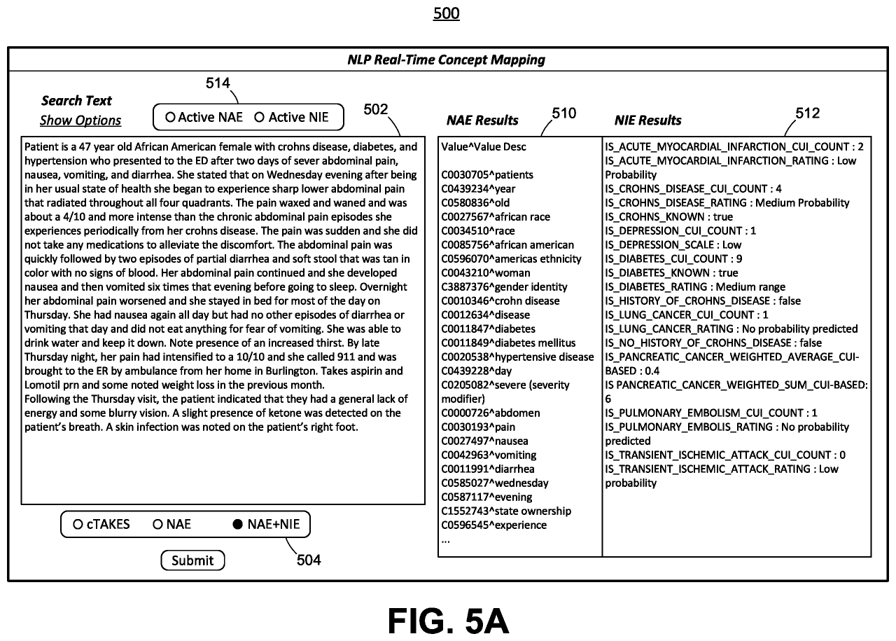

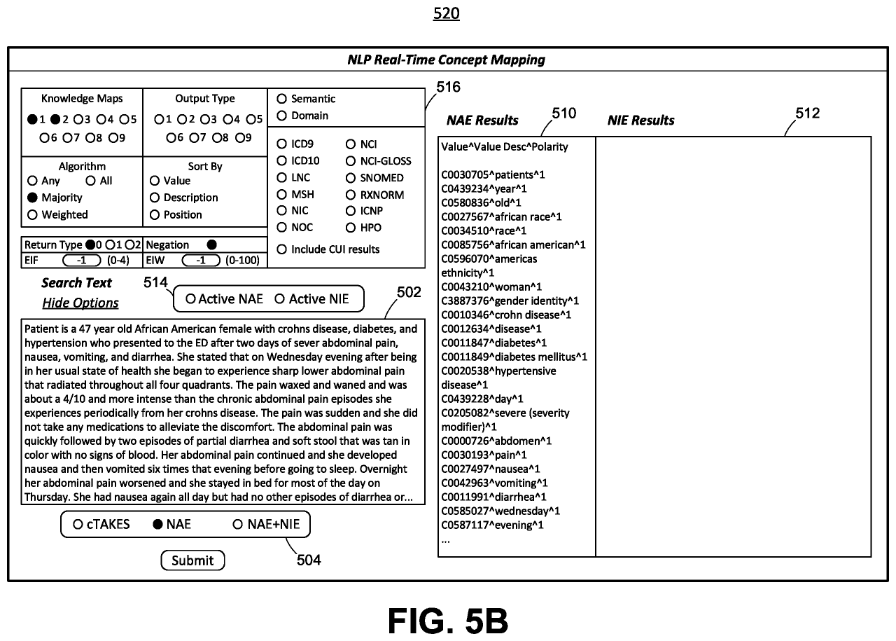

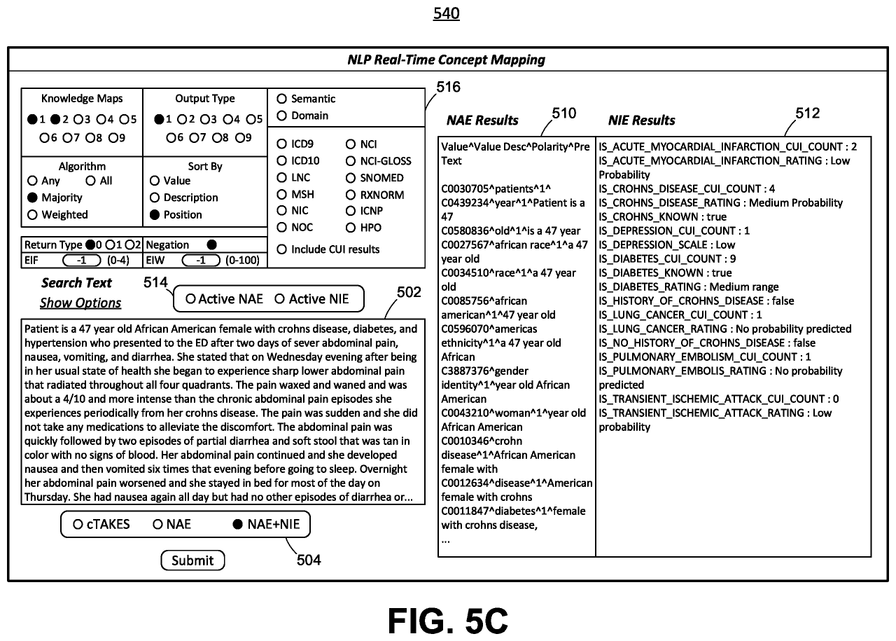

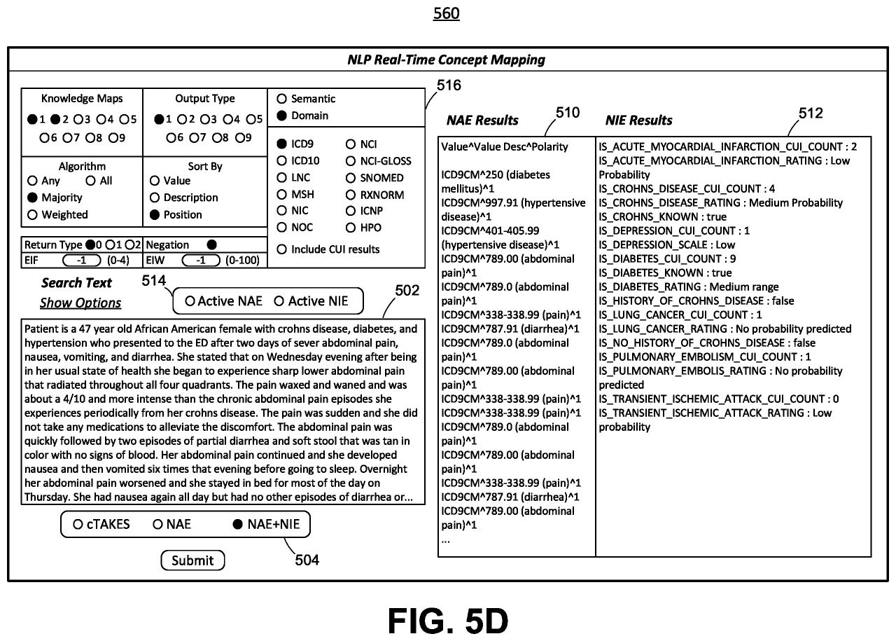

The client device 104 includes processing hardware 160, a network interface 162, a display 164, a user input device 166, and a memory 168. The processing hardware 160 may include one or more GPUs and/or one or more CPUs, for example, and the network interface 162 may include any suitable hardware, firmware, and/or software configured to use one or more communication protocols to communicate with external devices and/or systems (e.g., the server 102 and possibly the computing system(s) of the data source(s) 106, etc.) via the network 110. The display 164 may use any suitable display technology (e.g., LED, OLED, LCD, etc.) to present information to a user, and the user input device 166 may include a keyboard, a mouse, a microphone, and/or any other suitable input device or devices. In some embodiments, the display 164 and the user input device 166 are at least partially integrated within a single device (e.g., a touchscreen display). Generally, the display 164 and the user input device 166 may collectively enable a user to view and/or interact with visual presentations (e.g., graphical user interfaces or other displayed information) output by the client device 104, and/or to enter spoken voice data, e.g., for purposes such as selecting or entering data records (e.g., via typing or dictation), selecting particular inferencing rules to apply, and so on. Some example user interfaces are discussed below with reference to FIGS. 5-8.

The memory 168 may include one or more volatile and/or non-volatile memories (e.g., ROM and/or RAM, flash memory, SSD, HDD, etc.). Collectively, the memory 168 may store the instructions of one or more software applications, the data received/used by those applications, and the data output/generated by those applications. In the example embodiment of FIG. 1, the memory 168 stores the software instructions of a web browser 170, which the user may launch and use to access the server 102. More specifically, the user may use the web browser 170 to visit a website with one or more web pages, which may include HyperText Markup Language (HTML) instructions, JavaScript instructions, JavaServer Pages (JSP) instructions, and/or any other type of instructions suitable for defining the content and presentation of the web page(s). Responsive to user inputs, the web page instructions may call the REST API 127 of the cNIE 126 and/or the REST API 129 of the cNAE 128 in order to access the functionality of the cNIE 126 and/or cNAE 128, respectively, as discussed in further detail below. Alternatively, the cNIE 126 includes instructions that call the REST API 129 of the cNAE 128 (e.g., if the cNAE 128 is native to the cNIE 126). In other embodiments, the client device 104 accesses the server 102 by means other than the web browser 170.

In still other embodiments, the system 100 omits the client device 104 entirely, and the display 164 and user input device 166 are instead included in the server/system/device 102 (e.g., in embodiments where remote use is not required and/or supported). For example, the server 102 may instead be a personal device (e.g., a desktop or laptop computer, a tablet, a smartphone, a wearable electronic device, etc.) that performs all of the processing operations of the cNIE 126 and/or cNAE 128 locally. The highly efficient processing techniques of the cNIE 126 and cNAE 128 make this possible even with very low-cost computer hardware, in some embodiments. For example, the system 100 may omit the client device 104 and network 110, and the device 102 may be a Raspberry Pi device, or another low-cost device with very limited processing power/speed.

The data source(s) 106 may include computing devices/systems of hospitals, doctor offices, and/or any other institutions or entities that maintain and/or have access to health data repositories (e.g., EHRs) or other health data records, for example. In other embodiments and/or scenarios, the data source(s) 106 may include other types of records. For example, if the cNIE 126 and/or cNAE 128 are instead used for legal analysis, the data source(s) 106 may instead include servers or other systems/devices that maintain and/or provide repositories for legal documents (e.g., statutes, legal opinions, legal treatises, etc.). Generally, the data source(s) 106 are configured to provide structured and/or unstructured data to the server 102 via the network 110 (e.g., upon request from the server 102 or the client device 104). In some embodiments, the system 100 omits the data source(s) 106. For example, the cNIE 126 and/or cNAE 128 may instead operate solely on data records provided by a user of the client device 104, such as typed or dictated notes entered by the user via the user input device 166.

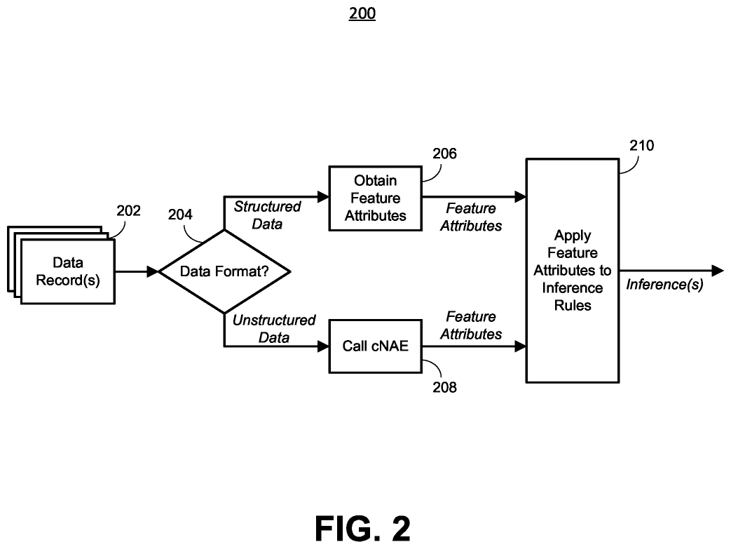

The operation of the cNIE 126 as executed by the processing hardware 120, according to one embodiment, is shown in FIG. 2 as process 200. In the process 200, the cNIE 126 initially obtains one or more data records 202. The cNIE 126 may obtain the data record(s) 202 from the data source(s) 106 (e.g., in response to user selections made via user input device 166, or by executing automated scripts, etc.), and/or directly from a user of the cNIE 126 (e.g., by receiving notes or other information typed in or dictated by a user of the client device 104 via the user input device 166), for example. Various examples of data records that may be entered by a user are discussed below with reference to, and/or are shown in, FIGS. 5-9. Generally, the data record(s) 202 may include any type of structured (e.g., coded) data, unstructured textual data, and/or metadata (e.g., data indicative of a file type, source type, etc.).

At stage 204, the cNIE 126 identifies/distinguishes any structured and unstructured data within the data record(s) 202. Stage 204 may include determining whether data is “structured” by identifying a known file type and/or a known file source for each of the data record(s) 202 (e.g., based on a user-entered indication of file type and/or source, or based on a file extension, etc.), by searching through the data record(s) 202 for known field delimiters associated with particular types of data fields (and treating all other data as unstructured data), and/or using any other suitable techniques.

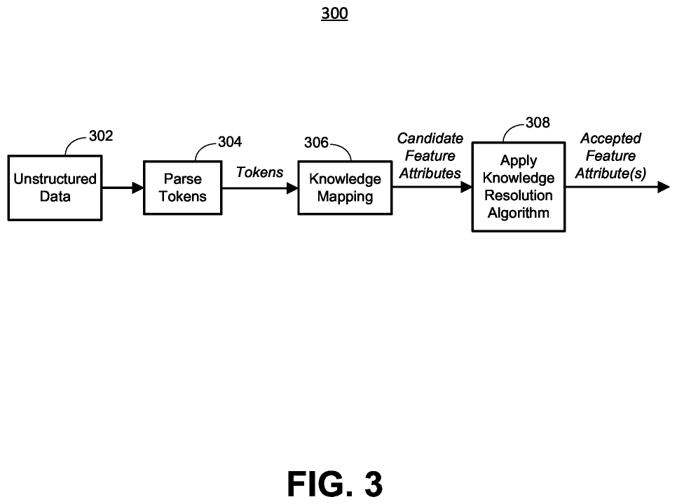

At stage 206, the feature attribute unit 132 of the cNIE 126 obtains/extracts feature attributes from the structured data of the data record(s) 202 (e.g., using field delimiters, or a known ordering of data in a particular file type, etc.). At stage 208, to obtain feature attributes from the unstructured data, the feature attribute unit 132 transparently calls the cNAE 128 (via REST API 129) and provides the unstructured data to the cNAE 128. In other embodiments, the feature attribute unit 132 instead calls a different (e.g., non-native) NLP engine at stage 208. For example, the feature attribute unit 132 may instead call (and provide the unstructured data to) cTAKES or another suitable NLP engine at stage 208. The cNAE 128 (or other NLP engine) processes the unstructured data according to its NLP algorithm(s) (e.g., as discussed in further detail below with reference to FIGS. 3 and 4), and outputs analytics as additional feature attributes. In some scenarios, the feature attribute unit 132 at stage 204 is unable to identify any structured data in the data records 202, or is unable to identify any unstructured data in the data record(s) 202, in which case stage 206 or 208, respectively, does not occur.

At stage 210, the rules engine 134 of the cNIE 126 applies any feature attributes from stages 206 and/or 208 as inputs to one or more inference rules from the inference rule database 136. Various examples of inference rules that may be applied at stage 210 are provided below. The cNIE 126 may select which inference rules to apply based on any data record information that is provided to the cNIE 126 via the REST API 127. This may include, for example, selecting inference rules based on user indications/selections of which inference rules to use (e.g., as entered via user input device 166) or in other embodiments, the cNIE 126 may intelligently select inference rules based on data record content (e.g., by automatically selecting inference rules where the data record content satisfies the inference rule criteria). In some embodiments and/or scenarios, the cNIE 126 selects one or more inference rules based on associations with other rules that have already been selected by a user, or have already been selected by the cNIE 126 (e.g., based on known/stored relationships, rules that embed links/calls to other rules, etc.).

The rules engine 134 applies the selected/identified rules to the feature attributes to output an inference, which may be any type of information appropriate to the use case (e.g., one or more diagnoses, one or more predictions of future adverse health outcomes, and so on). The inferred information may be used (e.g., by web browser 170) to generate or populate a user interface presented to a user via the display 164, or for other purposes (e.g., providing the information to another application and/or a third party computing system for statistical processes, etc.).

In some embodiments, the rules engine 134 implements a multi-thread process to concurrently evaluate multiple selected inference rules, thereby greatly reducing processing times at stage 210. Moreover, if the cNIE 126 utilizes the native cNAE 128, the processing at stage 208 may implement multi-thread processing to concurrently apply multiple knowledge maps (as discussed further below with reference to FIGS. 3 and 4). Thus, at least in embodiments where the cNAE 128 is called at stage 208 (e.g., rather than cTAKES), the entire process 200 (or possibly just stages 204 through 210, or stages 206 through 210) can occur substantially in real time. This can be particularly valuable in clinical diagnosis support (CDS), clinical research, and other applications where long processing times discourage use and/or make certain tasks (e.g., processing numerous and/or very large data records) impractical.

The operation of the cNAE 128 as executed by the processing hardware 120 (e.g., at stage 208, or independently of the cNIE 126), is shown in FIG. 3 as process 300, according to one embodiment. In the process 300, the cNIE 126 initially obtains unstructured textual data 302. The cNIE 126 may obtain the unstructured data 302 either from the cNIE 126 (e.g., at stage 208, when the cNIE 126 calls the REST API 129 of the cNAE 128), from a different inference engine, or more generally from any user or suitable application, system, etc.

At stage 304, the parsing unit 140 parses the unstructured data 302 into tokens (e.g., words, phrases, etc.). The parsing unit 140 passes the tokens to the candidate attribute unit 142, which at stage 306 detects features from the tokens, and maps the detected features to concepts/information/knowledge using knowledge maps from the knowledge maps 146.

The candidate attribute unit 142 may execute a multi-thread process to concurrently apply multiple knowledge maps, thereby greatly reducing processing times at stage 306. In some implementations, the candidate attribute unit 142 applies some of the knowledge maps concurrently (and possibly asynchronously), but others sequentially (e.g., if a first knowledge map produces a feature attribute that is then input to a second knowledge map). The number and/or type of the knowledge maps can vary dynamically with each assessment request. Various examples of different types of knowledge maps (e.g., primary, secondary, etc.), as well as an example scheme according to which such maps may be arranged and interrelated, are discussed below with reference to FIG. 4.

Collectively, the knowledge maps applied by the candidate attribute unit 142 at stage 306 generate multiple candidate feature attributes, e.g., with each candidate feature attribute corresponding to a different knowledge map. Each candidate feature attribute represents information that, according to a particular knowledge map, is at least implicitly expressed by the unstructured data 302 (e.g., one or more disease codes, one or more demographic attributes of a patient, etc.). At stage 308, the attribute resolution unit 144 applies a knowledge resolution algorithm to some or all of the various candidate feature attributes to arbitrate as to which, if any, of those attributes will be accepted (i.e., deemed to constitute “knowledge”). In this manner, the attribute resolution unit 144 can leverage the diversity of perspectives and/or approaches represented by the knowledge maps 146 to increase the accuracy and/or reliability of the cNAE 128. For example, the attribute resolution unit 144 may prevent over-reliance on knowledge maps that are unverified, that represent extreme outliers, that are based on a faulty or incomplete analysis, and so on.

In one embodiment, the knowledge resolution algorithm applies an “appearance” strategy, wherein the attribute resolution unit 144 accepts as knowledge any feature attribute generated by any knowledge map. In another embodiment, the knowledge resolution algorithm applies a more restrictive “concurrence” strategy, wherein the attribute resolution unit 144 accepts a feature attribute as knowledge only if all knowledge maps (e.g., all primary knowledge maps applied at stage 308, or all of a relevant subset of those primary knowledge maps) generated that feature attribute.

In other embodiments, the knowledge resolution algorithm applies a “voting” strategy. In one such embodiment (“simple majority”), the attribute resolution unit 144 accepts a feature attribute as knowledge only if a majority of knowledge maps (e.g., a majority of all primary knowledge maps applied at stage 308, or a majority of a relevant subset of those primary knowledge maps) generated that feature attribute. In another embodiment (“weighted majority”), the attribute resolution unit 144 applies the same voting strategy, but assigns a weight to the strength of the “vote” from each of some or all of the participating knowledge maps. Either of the above alternatives (simple majority or weighted majority) may instead require exceeding a threshold other than 50% in order for the attribute resolution unit 144 to accept a given feature attribute as knowledge. Alternatively, the knowledge resolution algorithm may weight each participating knowledge map, and accept only the feature attribute generated by the most heavily weighted knowledge map (while discarding all others). In some embodiments, the attribute resolution unit 144 can selectively apply any one of a number of available knowledge resolution algorithms (e.g., any one of the knowledge resolution algorithms described above) for a given task. The attribute resolution unit 144 may make this selection based on a user designation (e.g., a designation made via user input device 166), for example, and/or based on other factors.

The attribute resolution unit 144 can perform its arbitration function for one or more feature attributes, depending on the embodiment and/or scenario/task, and return the accepted feature attribute(s) to the cNIE 126 or another application. The cNIE 126 can make multiple calls of this sort to the cNAE 128 for a single inferencing task, if needed. In some embodiments, multi-thread processing enables the cNIE 126 to initiate multiple instances of the cNAE 128 concurrently (i.e., as needed, when the applied inference rule(s) require NLP support), with each of those cNAE 128 instances applying multiple knowledge maps concurrently. To reduce processing time and/or resources, in some embodiments, the cNIE 126 can cache NLP results (i.e., accepted feature attributes) received from the cNAE 128 during a particular inferencing task (e.g., in memory 124), and reuse those cached NLP results if the inferencing task requires them again (i.e., rather than calling the cNAE 128 again to repeat the same operation). In some embodiments, the cNIE 126 may cache results for reuse across multiple inferencing tasks/requests.

FIG. 4 depicts an example configuration 400 of knowledge maps that the cNAE 128 (e.g., the candidate attribute unit 142) may use to perform the knowledge mapping at stage 306 of FIG. 3. The knowledge maps shown in FIG. 4 may represent the particular knowledge maps selected by the cNAE 128 (from among the complete set of knowledge maps 146) to perform a particular task (e.g., for a particular call from the cNIE 126 via REST API 129), for example.

As noted above, knowledge maps may include “primary,” “secondary,” and “specialized” knowledge maps, in some embodiments. The configuration 400, for example, includes four primary knowledge maps 402 (PKM 1 through PKM 4), six secondary knowledge maps (SKM 1A through SKM 4B), and one or more specialized knowledge maps 406 that may be configured in various ways to perform specialized functions.

The primary knowledge maps PKM 1 through PKM 4 may each operate on the same set of features detected from the tokens output by the parsing unit 140, in order to perform initial characterization on the feature set. In the example shown, PKM 1 is associated with three secondary knowledge maps SKM 1A through SKM 1C, PKM 2 is associated with no secondary knowledge maps, PKM 3 is associated with one secondary knowledge map SKM 3, and PKM 4 is associated with two secondary knowledge maps SKM 4A and SKM 4B. In some embodiments, the secondary knowledge maps 404 are utilized in response to the respective primary knowledge maps 402 being selected, but do not necessarily operate on the outputs of the primary knowledge maps 402 as shown in FIG. 4. For example, some or all of the secondary knowledge maps 404 may instead operate (or also operate) directly on the feature set that was operated upon by the primary knowledge maps 402. In other embodiments, however, at least some of the secondary knowledge maps 404 also (or instead) operate on feature attributes generated by the respective primary knowledge maps 402.

Generally, the secondary knowledge maps 404 may perform a more detailed (or otherwise complementary) analysis to supplement the respective primary knowledge maps 402. For example, PKM 1 may determine whether non-Hodgkins lymphoma is expressed by the text features, while SKM 1A through SKM 1C may determine whether different, specific types of non-Hodgkins lymphoma (e.g., mantle cell, follicular, etc.) are expressed by the text features. As another example, SKM 1A may determine whether a specific type of non-Hodgkins lymphoma is expressed, while SKM 1B instead determines whether a specific stage of cancer is expressed, etc.

The specialized knowledge maps 406 generally perform functions not handled by the primary and secondary knowledge maps 402, 404. If a primary or secondary knowledge map 402 or 404 deduces that the feature set expresses a particular feature attribute (e.g., “diabetes”), for example, a specialized knowledge map 406 that specializes in “negation” may determine whether the feature set positively (“diabetes”) or negatively (“no diabetes”) expresses that feature attribute. Negation and/or other specialized knowledge maps 406 may be generalized such that the candidate attribute unit 140 can apply a single specialized knowledge map 406 to different types of feature attributes. Thus, for example, a negation knowledge map may be applied to the output of each of multiple (e.g., all) primary and/or secondary knowledge maps 402, 404. Other potential specialized knowledge maps 406 may include knowledge maps dedicated to error correction, knowledge maps dedicated to localization (e.g., detecting or correcting for local dialects), and so on.

It is to be understood that FIG. 4 depicts just one of a virtually unlimited number of possible knowledge map configurations. For example, there may be more or fewer primary knowledge maps 402 and/or secondary knowledge maps 404 than are shown in FIG. 4, or the secondary knowledge maps 404 and/or specialized knowledge maps 406 may be omitted, etc. As another example, outputs of all knowledge maps (including all primary knowledge maps 402) may be provided to one, some, or all of the specialized knowledge maps 406 (e.g., if the negation analysis is desired for all deduced feature attributes). As yet another example, a single secondary knowledge map 404 may be associated with multiple primary knowledge maps 402 (e.g., may be invoked only if all of the associated primary knowledge maps are selected), and may operate on outputs of each of those primary knowledge maps. Further still, the configuration 400 may implement feedback and/or multiple iterations. For example, the outputs of certain secondary knowledge maps 404 may be fed back into inputs of certain primary knowledge maps 402, and/or outputs of certain specialized knowledge maps 406 may be fed back into inputs of certain primary knowledge maps 402 and/or certain secondary knowledge maps 404, etc.

The candidate attribute unit 142 may implement multi-core, multi-thread computational processes to concurrently apply multiple knowledge maps within the configuration 400. In some embodiments and/or scenarios, however, certain knowledge maps are applied sequentially. For example, some knowledge maps may be applied sequentially where, as shown in FIG. 4, a secondary knowledge map 404 requires input from a primary knowledge map 402, where a specialized knowledge map 406 operates only after a primary or secondary knowledge map 402 or 404 has identified a feature attribute, and/or where a feedback configuration requires waiting for a particular knowledge map to provide an output, etc.

As described above, the attribute resolution unit 144 applies a knowledge resolution algorithm to different candidate feature attributes to arbitrate as to which, if any, of those attributes should be accepted as “knowledge” by the cNAE 128. While not shown in FIG. 4, the attribute resolution unit 144 applies the attribute resolution algorithm (or multiple attribute resolution algorithms) to the outputs of the primary knowledge maps 402. In some embodiments, secondary knowledge maps 404 associated with a given primary knowledge map 402 are only selected/utilized if the feature attribute(s) generated by the primary knowledge map 402 are accepted as knowledge by the attribute resolution unit 144.

If the attribute resolution unit 144 uses a “voting” strategy (as discussed above), or another strategy that jointly considers the outputs of multiple knowledge maps, the attribute resolution unit 144 may apply its knowledge resolution algorithm only to those knowledge maps that seek to deduce the same class of knowledge. For example, a voting algorithm may be applied jointly to PKM 1, PKM 2, and PKM 3 if all three knowledge maps seek to deduce whether features express a particular disease code, but would not jointly be applied to PKM 1, PKM 2, PKM 3, and PKM 4 if the latter (PKM 4) instead seeks to deduce whether features express demographic information (age, gender, etc.).

The outputs provided by the configuration 400, after the application of the attribute resolution algorithm(s) and subsequent (secondary and/or specialized) knowledge maps, may be the feature attributes that the cNAE 128 outputs at stage 308 in FIG. 3, and/or the feature attributes that the cNAE 128 outputs at stage 208 (and the cNIE 126 uses as inputs to the inference rules at stage 210) of FIG. 2, for example.

Merely for purpose of illustration, a number of example inference rules (e.g., applied at stage 210 of FIG. 2 by the rules engine 134) will now be provided, as expressed in pseudocode. While relatively simple inference rules are shown here for illustration purposes, it is understood that much more complex rules, or interrelated sets of rules, may be applied.

A first example inference rule, expressed in JavaScript Object Notation (JSON) format, infers whether structured data indicates a pediatric patient with a known history of asthma:

```
{
  “rule name”: “Peds with Known Asthma”,
  “description”: “Peds patient with known (history of) asthma.”,
  “required_attrs”: [
    {
      “name”: “NLP”,
      “type”: “NLP-COL”
    },
    {
      “name”: “Age”,
      “type”: “NUMERIC”
    }
  ],
  “cnae_parameters”: {
    “filter-section”: “HISTORY OF PRESENT ILLNESS”
    “negation”: 1
    “return-result”: 1
  },
  “is_active”: false,
  “attrs_values”: {
      “Age”: {
      “attribute”: “Age”,
      “value”: 13,
      “type”: “NUMERIC”,
      “operand”: “LT”,
      “eval_mode”: 0,
      “rule_id”: 29
      },
      “NLP”: {
      “attribute”: “NLP”,
      “value”: {
        “kmes”: [
        {
          “value”: “C0455544”,
          “value_desc”: “h/o: asthma”,
          “polarity”: 1
        },
        {
          “value”: “C0004096”,
          “value_desc”: “asthma”,
          “polarity”: 1
        }
      ]
    },
      “type”: “NLP-COL”,
      “operand”: “ONE-IN”,
      “eval_mode”: 0,
      “rule_id”: 29
    }
    },
    “bit_operations”: “OR”
}
```

A second example inference rule infers whether a combination of structured data and raw concept unique identifier (CUI) indicates pediatric fever with abdominal pain (e.g., for a clinical diagnosis):

```
RuleName: Pediatric Fever w/abdominal pain
RuleHash: Hash of sorted and concatenated RequiredAttrs
RequiredAttrs:
      AGE = Int/real
      TEMP = Numeric
      CUIs = collection of CUI
ReturnAttrs:
      Ped_Fever_Abd_Pain  =  Boolean  (Return  value  /  attribute  name:
IS_PED_FEVER)
      ProcessedID = UUID (UUID associate with this call)
      StatusCode = Status Code (Return status code for operation)
Rule: AGE < 13 && TEMP > 98.6 && CUIs in [“C0000737”, “C0232495”] then TRUE
else FALSE
Data passed via API
{
      “RuleNum”: 1,
      “RequiredAttrs” : [
        {
              “Attr”: “AGE”,
              “Operand” : “=”,
              “Value” : 10,
              “Type” : 0
        },
          {
              “Attr”: “TEMP”,
              “Operand” : “=”,
              “Value” : 100.2,
              “Type” : 2
          },
            {
              “CUIs” : [
              {
              “CUI” : “C0000737”
              }
              ]
              }
          ]
}
Data returned via API
{
        “Ped_Fever_Abd_Pain”: 1,
        “ProcessedID” : “BC23CD3212”,
        “StatusCode” : 0
}
```

A third example inference rule infers whether a combination of structured data and a raw clinical note (e.g., typed or dictated by a user) indicates pediatric fever with abdominal pain (e.g., for a clinical diagnosis), in part by calling an NLP engine (e.g., the cNAE 128, with the “API” referenced below being the REST API 129):

```
RuleName: Pediatric Fever w/abdominal pain
RuleHash: Hash of sorted and concatenated RequiredAttrs
RequiredAttrs:
      AGE = Int/Real
      TEMP = Numeric
      RAW_NOTE = String/Text (RAW_NOTE is always put to the n-gram API and
expects a list of CUIs to be returned)
ReturnAttrs:
      Ped_Fever_Abd_Pain =  Boolean  (Return  value  /  attribute  name:
IS_PED_FEVER)
      ProcessedID = UUID (UUID associate with this call)
      StatusCode = Status Code (Return status code for operation)
Rule: AGE < 13 & & TEMP > 98.6 && CUIs in [“C0000737”, “C0232495”] then TRUE
else FALSE
Data passed via API
{
      “RuleNum”: 1,
      “RequiredAttrs” : [
        {
              “Attr”: “AGE”,
              “Operand” : “=”,
              “Value” : 10,
              “Type” : 0
      “},
        {
              “Attr”: “TEMP”,
              “Operand” : “=”,
              “Value” : 100.2,
              “Type” : 2
        },
          {  “Attr” : “RAW_NOTE”,
              “Operand” : “=”,
              “Value” : “Patient is a 10-year-old African American female with
diabetes presented to the ED after two days of severe abdominal pain, nausea, vomiting,
and diarrhea. She stated that on Wednesday evening after being in her usual state of
health she began to experience sharp lower abdominal pain that radiated throughout all
four quadrants. The pain waxed and waned and was about a 4/10 and more intense than
the chronic abdominal pain episodes she experiences periodically from her Crohn's
disease. The pain was sudden and she did not take any medications to alleviate the
discomfort.”,
              “Type” : 6 (Note: 6 is raw note to be processed via NLP)
        }
      }
  ]
}
Data returned via API
      RAW_NOTE is passed to NLP and return a list of distinct CUIs that are then
consumed and evaluation in the rule evaluation.
{
      “Ped_Fever_Abd_Pain”: 1,
      “ProcessedID” : “EC23CD3212”,
      “StatusCode” : 0
}
```

In some embodiments, the REST API 129 enables the cNIE 126 (or any other application calling the cNAE 128) to provide one or more operational parameters that the cNAE 128 will then use to perform NLP. For example, the REST API 129 may support calls to the cNAE 128 that specify a particular format in which the cNAE 128 is to generate feature attributes, particular knowledge maps that are to be used, particular weightings that the attribute resolution unit 144 is to apply, and so on. Table 1, below, provides some example parameters that may be supported by the REST API 129:

TABLE 1

| Parameter Name | Type | Description |
|---|---|---|
| input | String | Text to be processed and mapped. |
| | | e.g., |
| | | “input”: “Patient has no history of diabetes” |
| format | String | Style format in which results will be returned to user. |
| | | Default Value if parameter not passed: “json” |
| | | Possible values: |
| | | “json” → Results are returned as JSON object |
| | | “html” → Results are returned as HTML |
| | | e.g., |
| | | “format”: “html” |
| call-back-token-sent | String | Token provided to engine that is returned in results. |
| | | Used by user if desire to group results externally. |
| | | Will be returned in results as “call-back-token-return”. |
| | | e.g. |
| | | “call-back-token-sent”: “1234” |
| | | “call-back-token-sent”: “mygroup1” |
| | | “call-back-token-sent”: “e50d1224-00d7-4822-9807- |
| | | c860e0d7ed62” |
| ngram-size | Integer | Maximum size of n-gram to be evaluated against. |
| | | Upper bound inclusive (=3 → 1, 2, 3 \| = 5 → 1, 2, 3, 4, 5). |
| | | Default Value if parameter not passed: 3 |
| | | Possible values: n > 0 |
| | | e.g. |
| | | “ngram-size”: 4 |
| negation | Integer | Flag to enable negation module in engine. |
| | | Default Value if parameter not passed: 0 |
| | | Possible values: |
| | | 0 → Negation module is disabled |
| | | 1 → Negation module is enabled |
| | | e.g. |
| | | “negation”: 1 |
| n-ngram-size | Integer | [Requires “negation”: 1] |
| | | Maximum size of n-gram to be evaluated against in the |
| | | negation module. |
| | | Upper bound inclusive (=3 → 1, 2, 3) |
| | | Default Value if parameter not passed: 3 |
| | | Possible values: n > 0 |
| | | e.g. |
| | | “n-ngram-size”: 4 |
| n-ngram-pos-delta | Integer | [Requires “negation”: 1] |
| | | Maximum positions preceding mapped value to |
| | | evaluate for negation values. |
| | | Upper bound inclusive (=2 → 1, 2) |
| | | Default Value if parameter not passed: 2 |
| | | Possible values: n > 0 |
| | | e.g. |
| | | “n-ngram-pos-delta”: 3 |
| pre-text | Integer | Flag to enable pre-text of mapped value to be returned |
| | | in results. |
| | | Default Value if parameter not passed: 0 |
| | | Possible values: |
| | | 0 → pre-text results are disabled |
| | | 1 → pre-text results are enabled |
| | | e.g |
| | | “pre-text”: 1 |
| post-text | Integer | Flag to enable post-text of mapped value to be returned |
| | | in results. |
| | | Default Value if parameter not passed: 0 |
| | | Possible values: |
| | | 0 → post-text results are disabled |
| | | 1 → post-text results are enabled |
| | | e.g. |
| | | “post-text”: 1 |
| position | Integer | Flag to enable position of mapped value in text to be |
| | | returned in results. |
| | | Default Value if parameter not passed: 0 |
| | | Possible values: |
| | | 0 → position results are disabled |
| | | 1 → position results are enabled |
| | | e.g. |
| | | “position”: 1 |
| importance | Integer | Flag to enable importance of mapped value in text to be |
| | | returned in results. |
| | | Default Value if parameter not passed: 0 |
| | | Possible values: |
| | | 0 → importance results are disabled |
| | | 1 → importance results are enabled |
| | | e.g. |
| | | “importance”: 1 |
| return-result | Integer | Determines how mapped values are filtered in result. |
| | | Default Value if parameter not passed: 1 |
| | | Possible values: |
| | | 0 → all mapped values are returned. End Position |
| | | Analysis (EPA) is applied. |
| | | 1 → only distinct mapped values are returned. EPA is |
| | | applied |
| | | 2 → only negated mapped values are returned. |
| | | Requires negation module to be enabled. |
| | | 3 → all mapped values are returned. |
| | | e.g. “return-result”: 3 |
| voting-alg | Integer | Enables voting between Knowledge Maps (KMs). |
| | | Default Value if parameter not passed: 0 |
| | | Possible values: |
| | | 0 → voting is disabled. |
| | | 1 → voting with Any algorithm is enabled |
| | | 2 → voting with Common algorithm is enabled |
| | | 3 → voting with Majority algorithm is enabled |
| | | 4 → voting with Weight algorithm is enabled |
| | | e.g. |
| | | “voting-alg”: 3 |
| target-kms | String, | Specifies which KMs will be used in concept mapping. |
| | array of | If parameter not passed, all KMs loaded in the engine |
| | strings, | will be used. |
| | array of | e.g. |
| | integers | type: string (must be separated by comma) (values can |
| | | be KM name or KM ID) |
| | | “target-kms”: “km1, km2, km3” |
| | | “target-kms”: “1, 4” |
| | | type: array of strings (values are KM name) |
| | | “target-kms”: [“km1”, “km2”, “km4”] |
| | | type: array of Integers (values are KM ID) |
| | | “target-kms”: [1, 3, 4] |
| sorting | Integer | Specifies how results will be sorted on return. |
| | | Possible values: |
| | | 0 → sorting is disabled |
| | | 1 → results sorted on Value |
| | | 2 → results sorted on Value Description |
| | | 3 → results sorted on Value Position |
| | | e.g. |
| | | “sorting”: 3 |
| eif-filter | Integer | Sets filter on Element Importance Factor (EIF) on |
| | | results. If parameter value is negative, no filter applied. |
| | | Upper bound inclusive (=2 → 1, 2). |
| | | Default Value if parameter not passed: −1 |
| | | Possible values: 0 <= n <= 4 |
| | | e.g. |
| | | “eif-filter”: 3 |
| eiw-filter | Integer | Sets filter of Element Importance Weight (EIW) on |
| | | results. If parameter value is negative, no filter applied. |
| | | Upper bound inclusive (=40 → <= 40). |
| | | Default Value if parameter not passed: −1 |
| | | Possible values: 0 <= n <= 100 |
| | | e.g. |
| | | “eiw-filter”: 85 |
| secondary-result | Integer | Enables secondary value concept mapping. |
| | | Specifies how secondary value results are presented. |
| | | Default Value if parameter not passed: −1 |
| | | −1 → secondary value concept mapping disabled |
| | | 0 → returns secondary values as linked value to |
| | | primary value |
| | | 1 → returns secondary values as linked value to |
| | | primary value. Exclude primary values that do not meet |
| | | secondary value filter criteria |
| | | 2 → returns secondary values as individual values |
| | | 3 → returns secondary values as individual values. |
| | | Excludes all primary values. |
| | | e.g. |
| | | “secondary-result”: 3 |
| secondary-kms | String, | [Requires that “secondary-result” be set] |
| | array of | Specifies which Secondary KMs (SKMs) will be used |
| | strings, | in secondary value concept mapping. If parameter not |
| | array of | passed, no secondary values will be returned. |
| | integers | e.g. |
| | | type: string (must be separated by comma) (values can |
| | | be SKM name or SKM ID) |
| | | “secondary-kms”: “km1_1, km1_3” |
| | | “secondary-kms”: “1.1, 1.3” |
| | | type: array of strings (values are SKM name) |
| | | “secondary-kms”: [“km1_1”, “km1_2”] |
| | | type: array of Integers (values are SKM ID) |
| | | “secondary-kms”: [1.1, 1.3] |
| secondary-k-filter | String, | [Requires that “secondary-result” be set] |
| | array of | Filters secondary values based on the key. |
| | strings | All conditions met by filter(s) will be returned. |
| | | Wildcards supported. Can be used in junction with |
| | | “secondary-v-filter”. |
| | | e.g. |
| | | type: string (must be separated by comma) |
| | | “secondary-k-filter”: “ICD9*” |
| | | “secondary-k-filter”: “LNC, ICD10CM” |
| | | type: array of strings |
| | | “secondary-k-filter”: [“ICD9CM”, “L*C”] |
| secondary-v-filter | String, | [Requires that “secondary-result” be set] |
| | array of | Filters secondary values based on the value. |
| | strings | All conditions met by filter(s) will be returned. |
| | | Wildcards supported. Can be used in junction with |
| | | “secondary-k-filter”. |
| | | e.g. |
| | | type: string (must be separated by comma) |
| | | “secondary-v-filter”: “250.0, E08” |
| | | type: array of strings |
| | | “secondary-v-filter”: [“250.0”] |

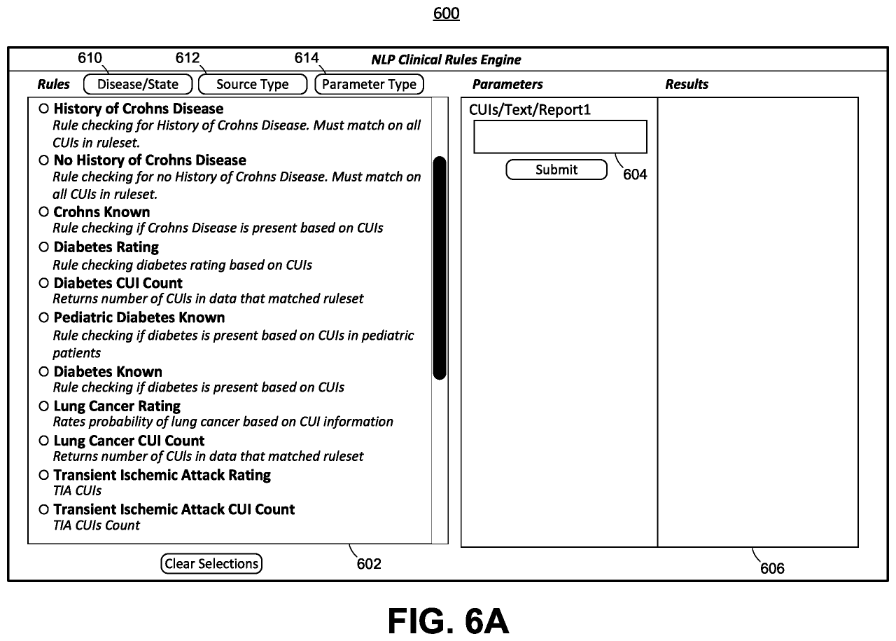

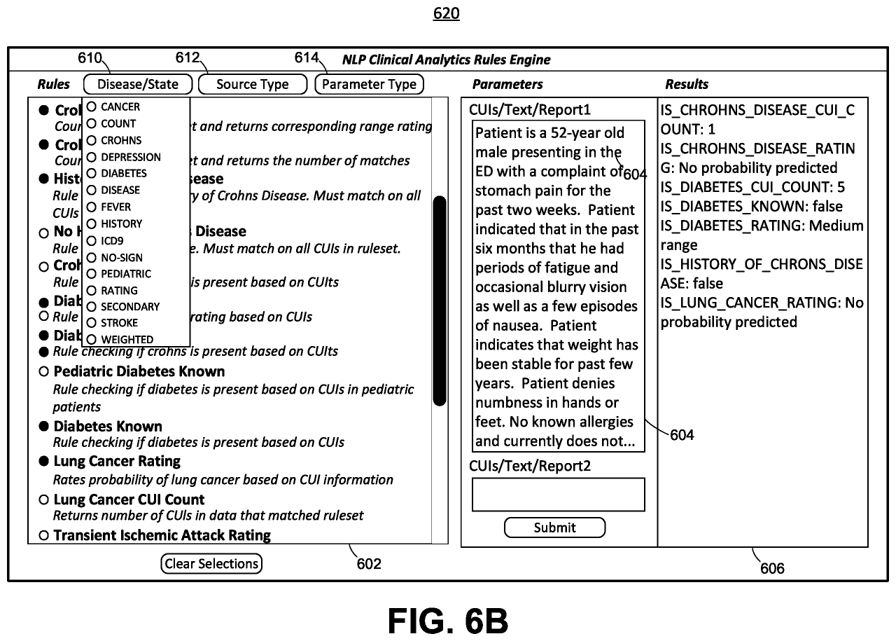

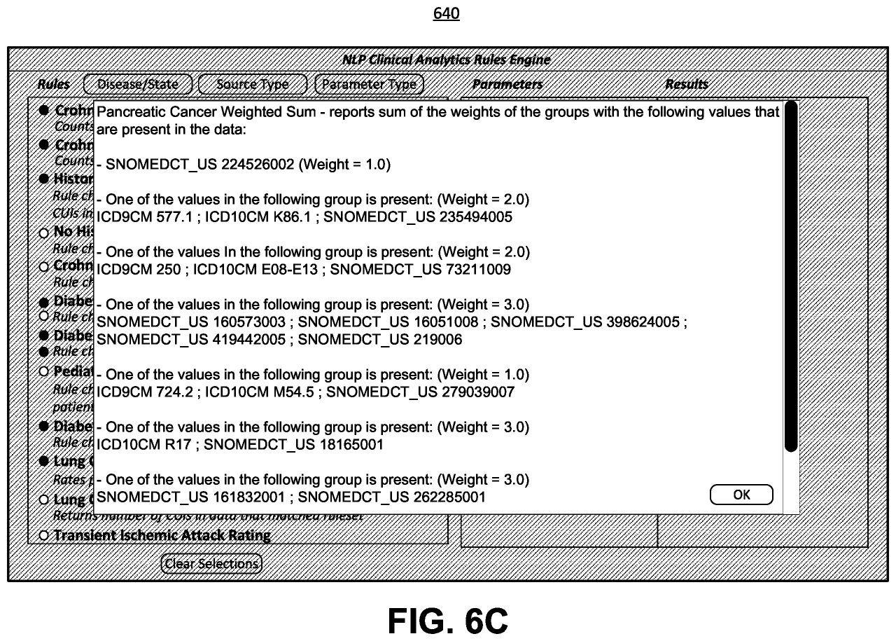

FIGS. 5A through 5D and FIGS. 6A through 6C are example user interfaces that may be utilized by the web browser 170 (or a stand-alone application executing on device 102 in an embodiment that excludes the client device 104, etc.) to interact with the cNIE 126 and/or cNAE 128. In particular, FIGS. 5A through 5D relate to usage of the cNIE 126 when incorporating the cNAE 128, while FIGS. 6A through 6C relate more specifically to usage of the cNIE 128.

Turning first to FIG. 5A, a user interface 500 provides a field 502 in which a user may enter (e.g., type, copy-and-paste, dictate with speech-to-text software, etc.) unstructured textual data. The user may also use controls 504 to select whether to apply the cNIE 126, the cNAE 128, the cNIE 126 and cNAE 128, or another clinical NLP engine (in this case, cTAKES) to the entered text. The output of the analytics engine (here, cNAE 128) is presented in field 510, and the output of the inference engine (cNIE 126) is presented in field 512. The data in field 510 may be feature attributes generated by the cNAE 128 at stage 208 and the date in field 512 may be inferenced information generated by the cNIE 126 at stage 210, for example. The control 514 allows the user to select “active NAE” (i.e., where the cNAE 128 processes the text in field 502 and provides outputs for display in field 510 as the user is entering the text) and/or “active NIE” (i.e., where the cNIE 126 processes the outputs of the cNAE 128 and provides outputs for display in field 512 as the user is entering the text). When neither of the radio buttons in control 514 is selected, results are only shown in fields 510 and/or 512 in response to the user selecting the “Submit” control.

FIG. 5B depicts a user interface 520 corresponding to the user interface 500 after the user has selected the “Show Options” control of user interface 500 (and also switched from “NAE+NIE” to just “NAE” using control 504). The expanded options control 516 enables the user to select specific knowledge maps (e.g., primary and possibly secondary and/or certain specialized knowledge maps), specific output types and formats (e.g., ICD9, ICD10, LOINC, MESH, etc.) to be provided by the cNAE 128 and/or cNIE 126, the attribute resolution algorithm to be applied (e.g., by the attribute resolution unit 144), a manner in which to sort outputs of the cNAE 128 and/or cNIE 126, whether negation (i.e., a particular specialized knowledge map) is to be applied, and so on.

FIG. 5C depicts a user interface 540 corresponding to the user interface 500 and 520, after the user has selected a different set of the options via the expanded options control 516 (and changed back from “NAE” to “NAE+NIE”). The selected output type and sorting technique affect the information/results shown in fields 510 and/or 512, as well as their order.

FIG. 5D depicts a user interface 560 corresponding to the user interfaces 500, 520, and 540, after the user has selected yet another set of the options via the expanded options control 516. Again, the selected output type and sorting technique affect the information/results shown in fields 510 and/or 512, as well as their order.

In the user interface 600 of FIG. 6A, a user can view and select from available inference rules (e.g., rules included in inference rule database 136) via control 602. The user-selected rules may be implemented by the rules engine 134 at stage 210, for example. In the example user interface 600, field 604 enables users to enter input data (e.g., unstructured notes), and field 606 enables users to view results (i.e., inferences output by the cNIE 126 using the selected inference rules). Also in the user interface 600, controls 610, 612, and 614 enable a user to filter rules by disease/state, source type, or parameter type, respectively.

FIG. 6B depicts a user interface 620 corresponding to the user interface 600 after the user has selected specific rules via control 602, entered input text in field 604, and selected “disease/state” via control 610 (causing a drop down menu with specific diseases/states to be presented, with each disease/state, if selected, causing relevant rules to be displayed in control 602). The user interface 620 also reflects a time after the user submitted the input in field 604. causing results to be displayed in field 606.

FIG. 6C depicts a user interface 640 corresponding to the user interfaces 600 and 620, after the user has selected a control that causes the user interface 640 to display more detailed information about a particular inference rule shown in control 602 (in this case, the “pancreatic cancer weighted sum” rule).

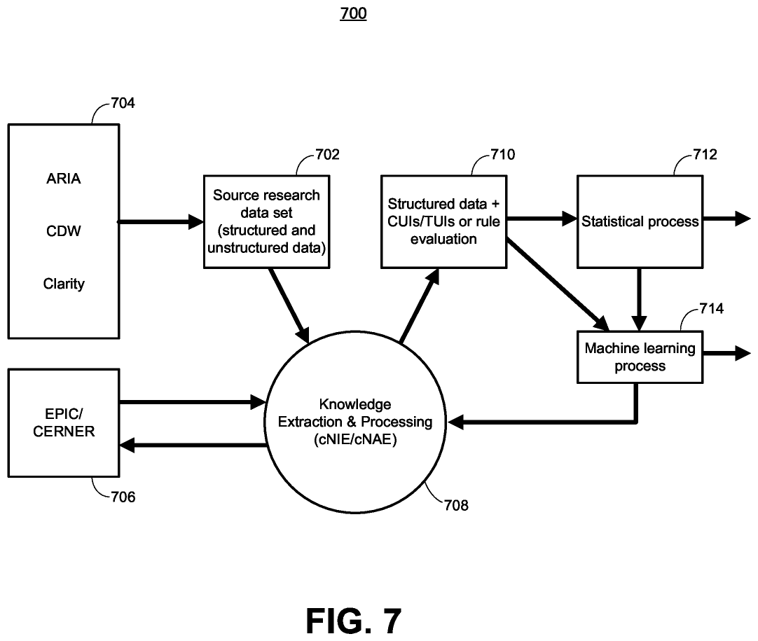

FIGS. 7 through 9 relate to example use cases for the cNIE 126 and cNAE 128. Turning first to FIG. 7, an example process 700 uses the inferencing and analytics capabilities of the system 100 of FIG. 1 for clinical research. In the example process 700, the cNIE 126 (or another application of the system 100) sources 702 a research data set, including structured and unstructured data, from various applications/sources 704, such as a Clinical Data Warehouse (CDW), Clarity databases, and/or other suitable data sources. The structured and unstructured data may be indicated (entered or selected) by a user via the user input device 166, for example. Other sourced data, in this example, includes data from EHR systems 706, such as Epic and/or Cerner systems. The sourced data from 702 and 706 is provided for knowledge extraction and processing 706, which represents the operations of the cNIE 126 with the cNAE 128 (e.g., according to any of the embodiments thereof discussed above).

For example, the cNIE 126 may select appropriate inference rules (e.g., based on user inputs or via automatic selection) and then identify the unstructured portions of the sourced research data set, and providing that unstructured data to the cNAE 128 via the REST API 129. The cNAE 128 may then process the unstructured data to generate feature attributes to provide to the cNIE 126. The cNIE 126 applies the inference rules to the feature attributes (and possibly also to structured data within the sourced research data set).

The inferenced information (rule evaluation) generated by the cNIE 126 during the processing 708 (and/or the feature attributes determined by the cNAE 128 during the processing 708) is combined with structured data from the applications/sources 704 and/or the EHR systems 706 to form process input data 710. Optionally, some or all of the inferenced information, feature attributes, and/or structured data is also provided to the EHR systems 706, to be stored in the appropriate data records. The process input data 710 may be provided to a statistical process 712 and/or a machine learning process 714 (e.g., for use as training data). Based on the outputs/results of the statistical process 712 and/or machine learning process 714, new, supporting inference rules may be built for the cNIE 126 (e.g., for inclusion in the inference rule database 136).

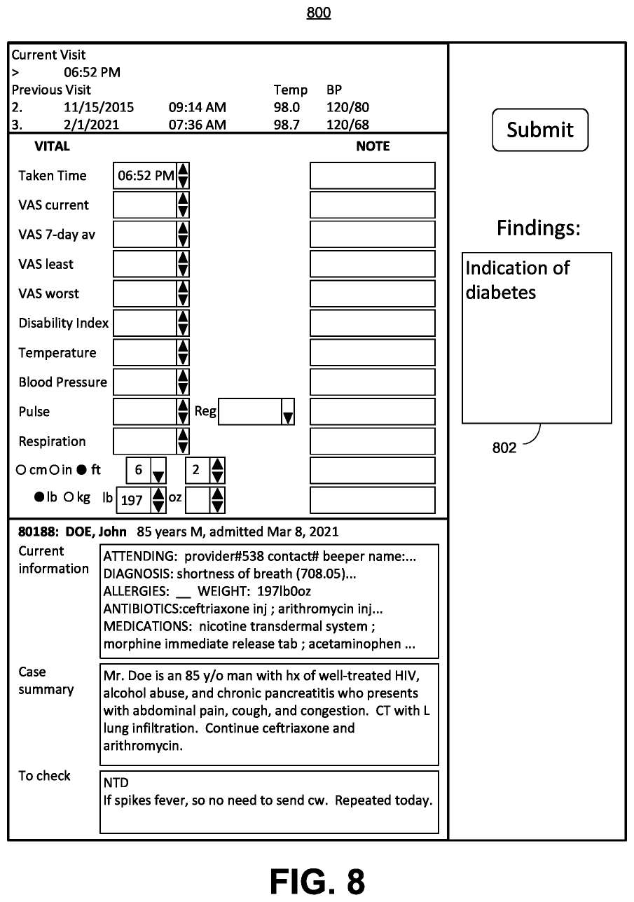

FIG. 8 depicts an example user interface 800 of a real-time clinical decision support (CDS) application that uses the inferencing and analytics capabilities of the system 100 of FIG. 1. The real-time CDS application may be the cNIE 126 (with cNAE 128), for example. In the user interface 800, the input information/text is provided via a clinical flowsheet, with both structured data (e.g., temperature, blood pressure, height, weight) and unstructured textual data (i.e., the contents of the “Current information,” “Case summary,” and “To check” fields). Substantially in real time after the user clicks “Submit” (or, in some embodiments, as a user enters information in the various fields), the cNIE 126 and cNAE 128 are called to process at least some of the structured and unstructured data to provide findings 802, which represent the output of the cNIE 126 inference rule(s). In this example, the findings 802 state that diabetes is indicated for the patient whose information is entered in the various fields. Given the highly efficient processing of the cNIE 126 and cNAE 128, a clinician may be able to observe and consider the findings 802, and provide advice to a patient based at least in part on the findings 802, all in the course of the patient's visit to the clinician's office.

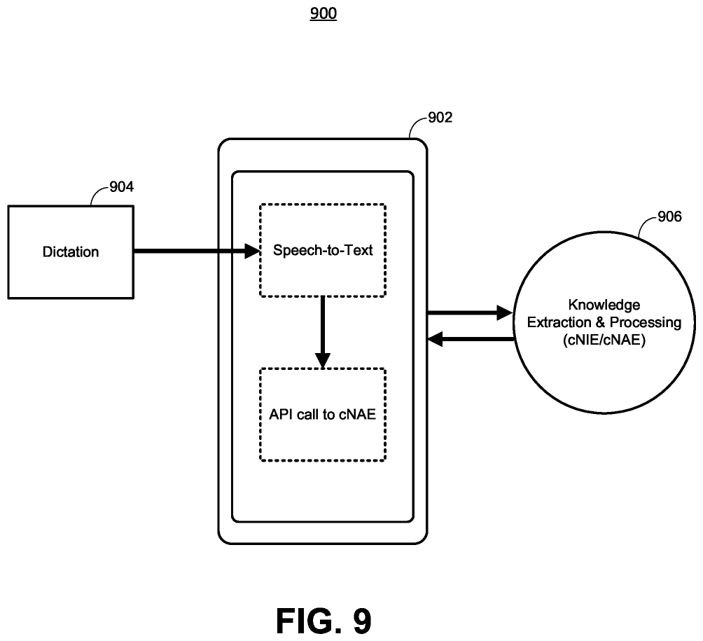

FIG. 9 depicts an example process 900 for using the inferencing and analytics capabilities of the system 100 of FIG. 1 on a personal device 902 with user dictation. In the process 900, the user (e.g., a clinician) dictates 904 notes into a microphone of the personal device 902 (e.g., while treating a patient). The personal device 902 may be a smartphone or tablet device, for example. With reference to FIG. 1, the personal device 902 may be the client device 104 (e.g., if cNIE 126 and cNAE 128 processing occurs at a remote server) or the device 102 (e.g., if the cNIE 126 and cNAE 128 processing occurs locally at the personal device 902). As the user dictates his or her notes, the personal device 902 (e.g., the cNIE 126 or an application not shown in FIG. 1) performs speech-to-text translation, and calls an API (e.g., the REST API 129) of the cNAE 128 to process the translated (but still unstructured) data. Depending on the embodiment, the personal device 902 may locally or remotely call the cNAE 128 directly (after which the cNAE 128 passes its determined feature attributes to the cNIE 126), or may indirectly call the cNAE 128 by first calling the cNIE 126 via the API 128 (after which the cNIE 126 calls the cNAE 128 via API 129). Once called, the cNIE 126 and cNAE 128 perform their knowledge extraction and processing 906 to return the rule evaluation information, which may then be presented to the user via the display of the personal device 902.

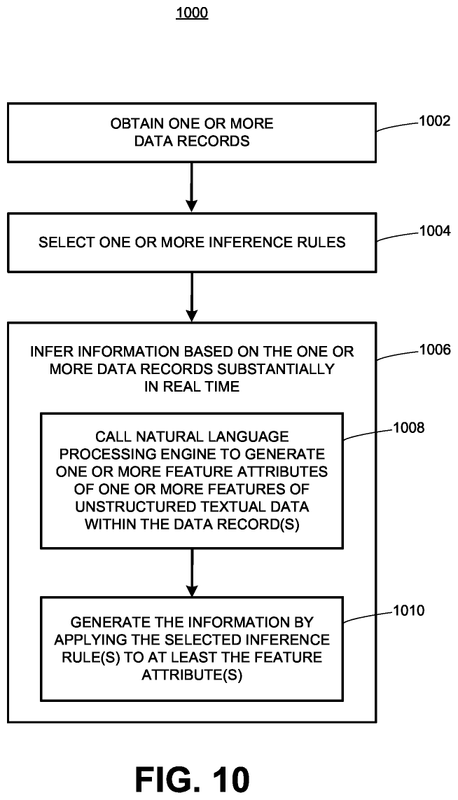

FIG. 10 is a flow diagram of an example method 1000 for efficiently inferring information from one or more data records, according to an embodiment. The method 1000 may be implemented in whole or in part by the cNIE 126 of FIG. 1 (e.g., by the processing hardware 120 when executing instructions of the cNIE 126 stored in memory 124), for example.

At block 1002 of the method 1000, one or more data records are obtained (e.g., from data source(s) 106 via network 110, and/or from client device 104 via user input device 166). Block 1002 may include retrieving or receiving data files based on user-entered data file or data source information, and/or automated scripts, for example. Alternatively, or in addition, block 1002 may include receiving a voice input from a user, and generating at least one of the data record(s) based on the voice input (e.g., using speech-to-text processing).

At block 1004, one or more inference rules are selected from among a plurality of inference rules (e.g., from inference rule database 136). For example, block 1004 may include selecting at least one of the inference rules based on the content of at least one of the one or more data records (e.g., as entered by a user via user input device 166, or as obtained by other means). The selected inference rule(s) may include one or more “composite” rules that reference, or are otherwise associated with, another of the selected inference rule(s). For example, block 1004 may include selecting a first inference rule based on a user input, and selecting a second inference rule automatically based on a link embedded in the first inference rule. In some embodiments and/or scenarios, at least one of the selected inference rule(s) is configured to recognize a plurality of clinical codes having different formats (e.g., ICD9, ICD10, SNOMED, etc.), and/or to recognize/understand different human languages (e.g., English, Spanish, Chinese, etc., and/or regional idiosyncrasies).

At block 1006, information is inferred (e.g., by the rules engine 134) substantially in real time (e.g., in less than 100 milliseconds, less than 10 milliseconds, less than 2 milliseconds, less than 1 millisecond, etc.) based on the data record(s) obtained at block 1002. The inferred information may include, for example, a clinical condition or characteristic. As more specific examples, the inferred information may include information indicating whether an individual exhibits the clinical condition or characteristic (i.e., a diagnosis), or information indicating a risk of having or developing the clinical condition or characteristic (i.e., a prediction). It is understood that non-clinical applications are also possible and within the scope of the disclosed inventions.

Block 1006 includes, at sub-block 1008, calling an NLP engine (e.g., via an API provided by the NLP engine) to generate one or more feature attributes of one or more features of unstructured textual data within the data record(s). The NLP engine may be a native NLP engine such as the cNAE 128 (e.g., called via REST API 129), for example, or may be another NLP engine such as cTAKES. Sub-block 1008 may include providing one or more NLP parameters (e.g., an output format, and/or any of the NLP parameters listed in Table 1) to the NLP engine via the API.

Block 1006 also includes, at sub-block 1010, generating the inferred information (e.g., by the rules engine 134) by applying the selected inference rule(s) to at least the feature attribute(s) generated at sub-block 1008. Sub-block 1010 may include executing a multi-core. multi-thread process to concurrently apply two or more inference rules to at least the feature attribute(s) generated at sub-block 1008, although just one inference rule may be used in particular scenarios.

In some embodiments and/or scenarios, sub-block 1008 includes calling the NLP engine multiple times concurrently or sequentially, and/or sub-block 1010 includes generating different portions of the inferred information concurrently or sequentially (according to different inference rules). For example, the NLP engine may be called one or more times to evaluate a first inference rule, and one or more additional times to evaluate a second inference rule. As these examples illustrate, sub-blocks 1008 and 1010 need not be performed strictly in the sequence shown in FIG. 10. Similarly, blocks 1002, 1004, and 1006 need not be performed strictly in the sequence shown in FIG. 10. For example, if “active” processing is selected via control 514 of FIGS. 5A through 5D, the operations of blocks 1002, 1004, and 1006 may overlap in time.

In some embodiments, sub-block 1008 includes caching of NLP engine results, to reduce the amount of duplicate processing operations and thereby reduce processing time and/or processing power. For example, sub-block 1008 may include calling the NLP engine to generate a first feature attribute when evaluating a first inference rule that operates upon the first feature attribute, caching the first feature attribute (e.g., storing the first feature attribute in memory 124 or another memory), and later retrieving the cached first feature attribute when evaluating a second inference rule that operates upon the first feature attribute, without having to call the NLP engine to once again generate the first feature attribute.

In some embodiments and/or scenarios, the method 1000 includes additional blocks and/or sub-blocks not shown in FIG. 10. For example, block 1006 may include an additional sub-block, occurring prior to at least a portion of sub-block 1008, in which the unstructured textual data is identified within the data record(s) (e.g., based on field delimiters or the lack thereof), and at least a portion of sub-block 1008 may occur in response to that identification of unstructured textual data. Further, block 1006 may include another sub-block in which structured data is identified within the data record(s), in which case sub-block 1010 may include applying the selected inference rule(s) to both the feature attribute(s) generated at sub-block 1008 and the structured data. As still another example, the method 1000 may include an additional block (occurring after block 1006) in which the inferred information is presented to a user via a display (e.g., via display 164), or used in statistical and/or machine learning processes as in FIG. 7, etc.

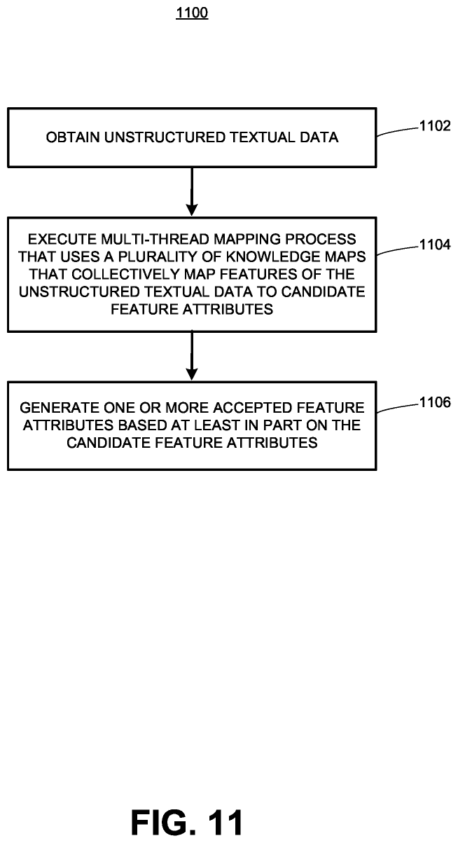

FIG. 11 is a flow diagram of an example method 1100 for efficient natural language processing of unstructured textual data, according to an embodiment. The method 1100 may be implemented in whole or in part by the cNAE 128 of FIG. 1 (e.g., by the processing hardware 120 when executing instructions of the cNAE 128 stored in memory 124), for example. In some embodiments, the method 1100 is implemented by a combination of the cNIE 126 and cNAE 128.

At block 1102 of the method 1100, unstructured textual data is obtained. Block 1102 may include using an API (e.g., REST API 129) to obtain the unstructured textual data, and/or receiving user input that is typed or dictated, for example.

At block 1104, a multi-thread mapping process is executed. The multi-thread mapping process uses a plurality of knowledge maps that collectively map features of the unstructured textual data to candidate feature attributes. The multi-thread mapping process is capable of concurrently using two or more of the knowledge maps (e.g., all of the knowledge maps, or all of the primary and secondary knowledge maps, etc.) to collectively map the features of the unstructured textual data to the candidate feature attributes. The knowledge maps may include any of the knowledge maps discussed above (e.g., mapping features to feature attributes based on semantics, positional information, etc.), including, in some embodiments, primary, secondary, and/or specialized knowledge maps (e.g., similar to those shown and described with reference to FIG. 4, and/or other suitable map types/configurations). The knowledge maps may be configured to map features to candidate feature attributes based on fixed associations between features and feature attributes (e.g., in a relational database), based on logical expressions, and/or using other suitable techniques, for example. In some embodiments, the method 1100 includes generating one or more of the knowledge maps using a machine learning model.

At block 1106, one or more accepted feature attributes are generated, based at least in part on the candidate feature attributes generated at block 1104. Block 1106 may include applying (e.g., by the attribute resolution unit 144) any of the attribute resolution algorithms discussed above (e.g., appearance algorithms that accept all candidate feature attributes from knowledge maps, algorithms that accept only candidate feature attributes that are common to all primary knowledge maps, that implement voting based on counts of how many primary knowledge maps output each candidate feature attribute, algorithms that implement weighted voting in which at least some of the counts are weighted differently, algorithms that accept only the candidate feature attribute associated with the most heavily weighted primary knowledge map, etc.), and/or any other suitable algorithms.

In some embodiments, the entire method 1100 occurs substantially in real time as the unstructured textual data is obtained (e.g., in less than 100 milliseconds, less than 10 milliseconds, less than 2 milliseconds, less than 1 millisecond, etc.). Moreover, in some embodiments and/or scenarios, the method 1100 may include additional blocks and/or sub-blocks not shown in FIG. 11. For example, the method 1100 may include an additional block, occurring before the multi-thread process uses the knowledge maps, in which at least one of the knowledge maps is selected based on user input (e.g., entered via user input device 166) and/or detected features. As yet another example, the method 1100 may include an additional block, occurring before the multi-thread process uses the knowledge maps, in which a primary knowledge map is selected, and a second additional block in which one or more secondary knowledge maps are selected based on the primary knowledge map (e.g., using a link within the primary map, or a known association between the primary and secondary maps). In other examples, the method 1100 includes an additional block (occurring after block 1106) in which the accepted feature attribute(s) (and/or one or more other feature attributes derived from the accepted feature attribute(s) using secondary and/or specialized knowledge maps, etc.) are presented to a user via a display (e.g., via display 164), and/or are provided as inputs to an inference engine that applies one or more inference rules to the feature attribute(s) (e.g., the cNIE 126).

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a method for efficiently processing data records with natural language processing and/or inference rules through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for efficiently inferring information from one or more data records, the method comprising:
obtaining, by processing hardware comprising one or more processors, the one or more data records;
selecting, by the processing hardware, one or more inference rules from among a plurality of inference rules;
inferring, by the processing hardware and substantially in real time, information based on the one or more data records, wherein inferring the information includes
calling a natural language processing (NLP) engine to generate one or more feature attributes of one or more features of unstructured textual data within the one or more data records, and
generating the information by applying the selected one or more inference rules to at least the one or more feature attributes.

2.-42. (canceled)

45. A method for efficient natural language processing of unstructured textual data, the method comprising:
obtaining, by processing hardware comprising one or more processors, the unstructured textual data;
executing, by the processing hardware, a multi-thread mapping process that uses a plurality of knowledge maps that collectively map features of the unstructured textual data to candidate feature attributes; and
generating, by the processing hardware, one or more accepted feature attributes based at least in part on the candidate feature attributes.

46. The method of claim 45, wherein the multi-thread mapping process concurrently uses two or more of the plurality of knowledge maps to collectively map the features of the unstructured textual data to the candidate feature attributes.

47. The method of claim 45, wherein at least one of the plurality of knowledge maps maps features to candidate feature attributes based on fixed associations between features and feature attributes.

48. The method of claim 45, wherein at least one of the plurality of knowledge maps maps features to candidate feature attributes based on logical expressions.

49. The method of claim 45, further comprising:
generating at least one of the plurality of knowledge maps using a machine learning model.

50. The method of claim 45, further comprising:
prior to the multi-thread mapping process using the plurality of knowledge maps, selecting, by the processing hardware, a primary knowledge map; and
selecting, by processing hardware, one or more secondary knowledge maps based on the primary knowledge map,
wherein the multi-thread mapping process uses the primary knowledge map to map the features of the unstructured textual data to the candidate feature attributes, and uses the one or more secondary knowledge maps to determine one or more additional feature attributes.

51. The method of claim 45, wherein at least one of the plurality of knowledge maps maps features to candidate feature attributes based on:
semantics of text within the unstructured textual data; and/or
positions of text within the unstructured textual data.

52. The method of claim 45, wherein at least one of the plurality of knowledge maps determines whether feature attributes are positively or negatively expressed in the unstructured textual data.

53. The method of claim 45, wherein the plurality of knowledge maps includes knowledge maps configured to recognize different clinical code formats.

54. The method of claim 45, wherein the plurality of knowledge maps includes a set of primary knowledge maps, and wherein generating the one or more accepted feature attributes includes:
selectively designating or not designating a particular candidate feature attribute as an accepted feature attribute based at least in part on a count of how many knowledge maps in the set of primary knowledge maps output the particular candidate feature attribute.

55. The method of claim 54, further comprising:
assigning, by the processing hardware, a respective weight to each of one or more of the knowledge maps in the set of primary knowledge maps,
wherein the counts are weighted counts determined in accordance with the one or more respective weights.

56. The method of claim 54, wherein selectively designating or not designating the particular candidate feature attribute as an accepted feature attribute includes:
designating or not designating the particular candidate feature attribute as an accepted feature attribute according to a voting scheme.

57. The method of claim 54, wherein selectively designating or not designating the particular candidate feature attribute as an accepted feature attributes includes:
designating or not designating the particular candidate feature attribute as an accepted feature attribute based on whether a threshold number of knowledge maps in the set of primary knowledge maps output the particular candidate feature attribute.

58. The method of claim 45, wherein the plurality of knowledge maps includes a set of primary knowledge maps, and wherein generating the one or more accepted feature attributes includes:
selectively designating or not designating a particular candidate feature attribute as an accepted feature attribute based on which knowledge map in the set of primary knowledge maps is weighted most heavily.

59. The method of claim 45, wherein obtaining the unstructured textual data, executing the multi-thread mapping process, and generating the one or more accepted feature attributes occur substantially in real time.

60. The method of claim 45, further comprising:
providing, by the processing hardware, the one or more accepted feature attributes, and/or one or more other feature attributes derived from the one or more feature attributes, as inputs to an inference engine that applies one or more inference rules to the one or more accepted feature attributes.

61. One or more non-transitory, computer-readable media storing instructions that, when executed by a computing system, cause the computing system to:
obtain unstructured textual data;
execute a multi-thread mapping process that uses a plurality of knowledge maps that collectively map features of the unstructured textual data to candidate feature attributes; and
generate one or more accepted feature attributes based at least in part on the candidate feature attributes.

62. The one or more non-transitory, computer-readable media of claim 61, wherein the multi-thread mapping process concurrently uses two or more of the plurality of knowledge maps to collectively map the features of the unstructured textual data to the candidate feature attributes.

63. The one or more non-transitory, computer-readable media of claim 61, wherein at least one of the plurality of knowledge maps maps features to candidate feature attributes based on fixed associations between features and feature attributes.
